(19) United States
(12) Patent Application Publication
(10) Pub. No.: US 2007/0285705 A1
(43) Pub. Date: Dec. 13, 2007

(54) System and method for testing readiness of a document processor

(75) Inventors: Marianne Kodimer, Huntington Beach, CA (US); Ken Stephenson, San Clemente, CA (US); Harpreet Singh, Orange, CA (US)

Correspondence Address: TUCKER ELLIS & WEST LLP, 1150 HUNTINGTON BUILDING, 925 EUCLID AVENUE, CLEVELAND, OH, 44115-1414, US

(73) Assignees: Kabushiki Kaisha Toshiba; Toshiba Tec Kabushiki Kaisha

(21) Appl. No.: 11/450,123

(22) Filed: Jun. 9, 2006

(51) Int. Cl. G06F 3/12

(52) U.S. Cl. 358/1.15

(57) ABSTRACT

A conditional document processor commencement system and method is provided. When a document processing device receives a document processing request, the device first determines whether a source document is present on the automatic document feeder or on the scanner device. A scan operation is initiated to detect the presence or absence of a source document. When no such source document is present, a visible alert is generated on an associated user-interface, illustrating to the user the absence of a source document. The user is then prompted to provide a source document to the document processing device. A second scan operation occurs and when the source document is present, the requested document processing operation is completed.

### BACKGROUND OF THE INVENTION

This invention is directed to a system and method for the conditional commencement of a document processing operation. In particular, this invention is directed to a system and method for detecting the presence of a source document prior to the commencement of a document processing operation.

Current document processing devices, such as multifunctional peripheral devices, allow a user to scan or otherwise generate an electronic document for further processing, such as scanning, storage, or distribution. The current devices are configured on the assumption that the user will place the document in the functionally proximate position, such as on the glass for scanning or in the automatic document feeder, before commencing the document processing operation. Usability tests, however, have shown that a user will often forget to place the document in the proper location prior to commencing the document processing operation and then, the resultant image data is blank. In such situations, a document processing device advances to the next step of the document processing operation as if the user had placed the document in the proper location. The user must first notice an error, and must then correct the problem, suitably either by cancelling the document processing operation or going backwards in the document processing operation configuration set up or menu. Correcting the problem after the commencement of the document processing operation requires more of the user's time and may frustrate the user. This also results in a waste of operation time of a device, which may be particularly problematic when multiple users are waiting to use a shared device. This also results in wasted stock, such as paper, which is processed and ejected without any usable image thereon. In addition, the user may not notice the error immediately and the may proceed with the document processing operation, resulting in a more costly error, as the user will have to spend time performing the operation again and if the operation was for a fee, will have to pay additional fees. As such, there is a need for a system and method for detecting the presence of a source document prior to the commencement of a document processing operation.

The subject application overcomes the above mentioned problems and provides a system and method for the conditional commencement of a document processing operation.

### SUMMARY OF THE INVENTION

In accordance with the subject application, there is provided a system and method for the conditional commencement of a document processing operation.

Still further, in accordance with the subject application, there is provided a system and method for detecting the presence of a source document prior to the commencement of a document processing operation.

Still further, in accordance with the subject application, there is provided a system and method for preventing user errors in the operation of a document processing device.

Still further, in accordance with the subject application, there is provided a system for the conditional commencement of a document processing operation. The system includes input means adapted for receiving status data from an associated document processing device, wherein the status data is representative of at least one of a presence or absence of a tangible document in a functionally proximate relationship relative to the associated document processing device for processing thereby. The system also includes means adapted for receiving an operation commencement input from an associated user. Such input is directed to commence at least one selected document processing operation on an associated, tangible document by the associated document processing device. The system further includes means adapted for selectively generating a visual alert to the associated user after receipt of operation commencement input and in accordance with received status data. The visual alert includes a display of information informing the associated user that the tangible document is not functionally proximate to the at least one selected document processing device. The system also comprises means adapted for selectively commencing a document processing operation on the tangible document when received status data indicates a functionally proximate relationship.

Still further, in accordance with the subject application, there is provided a method for the conditional commencement of a document processing operation. Status data is first received from an associated document processing device, which status data is representative of at least one of a presence or absence of a tangible document in a functionally proximate relationship relative to the associated document processing device for processing thereby. An operation commencement input is then received from an associated user, which input is directed to commence at least one selected document processing operation on an associated, tangible document by the associated document processing device. A visual alert is then selectively generated to the associated user after receipt of operation commencement input and in accordance with received status data. Such visual alert includes a display of information informing the associated user that the tangible document is not functionally proximate to the at least one selected document processing device. A document processing operation is then selectively commenced on the tangible document when received status data indicates a functionally proximate relationship.

Preferably, the document processing device includes at least one of a copying device, facsimile device, a scanning device, a printing device, and a multifunctional peripheral device.

In one embodiment of the subject application, the system and method further include commencing a scanning operation via scanning device associated with the document processing device and testing scan data resultant from the scanning operation. Status data is then selectively generated in accordance with an output of the testing means. A thumbnail display may then be generated corresponding to the scan data. In addition, an electronic document may be generated which is representative of an image associated with the tangible document. Such electronic document may be transmitted to at least one selected recipient, such as a device for receiving electronic mail or a facsimile device. A tangible copy of an image associated with the tangible document may also be generated.

Still other advantages, aspects and features of the subject application will become readily apparent to those skilled in the art from the following description wherein there is shown and described a preferred embodiment of this invention, simply by way of illustration of one of the best modes best suited to carry out the invention. As it will be realized, the invention is capable of other different embodiments and its several details are capable of modifications in various obvious aspects all without departing from the scope of the invention. Accordingly, the drawing and descriptions will be regarded as illustrative in nature and not as restrictive.

### BRIEF DESCRIPTION OF THE DRAWINGS

The subject invention is described with reference to certain figures, including:

FIG. 1 which is an overall system diagram of the system for the conditional commencement of a document processing device according to the subject application;

FIG. 2 is a block diagram illustrating device hardware for use in the system for the conditional commencement of a document processing device according to the subject application;

FIG. 3 is a functional block diagram illustrating the device for use in the system for the conditional commencement of a document processing device according to the subject application;

FIG. 4 is a block diagram illustrating controller hardware for use in the system for the conditional commencement of a document processing device according to the subject application;

FIG. 5 is a functional block diagram illustrating the controller for use in the system for the conditional commencement of a document processing device according to the subject application;

FIG. 6 is a flowchart illustrating the method for the conditional commencement of a document processing device according to the subject application; and

FIG. 7 is a template illustrating a screen presented to the user according to the subject application.

### DETAILED DESCRIPTION OF THE PREFERRED EMBODIMENT

The subject application is directed to a system and method for the conditional commencement of a document processing operation. In particular, the subject application is directed to a system and method for detecting the presence or absence of a source document prior to the commencement of a document processing operation. In accordance with one embodiment of the subject application, the document processing device is representative of a document processing services kiosk, suitably adapted to provide a variety of document processing services to a mobile user. More preferably, the document processing device is one of a plurality of such devices communicatively coupled to a fee-based document processing services system. In accordance with the subject application, a mobile user is provided access to the document processing device in an office or non-office environment, such as an airport lounge or business center.

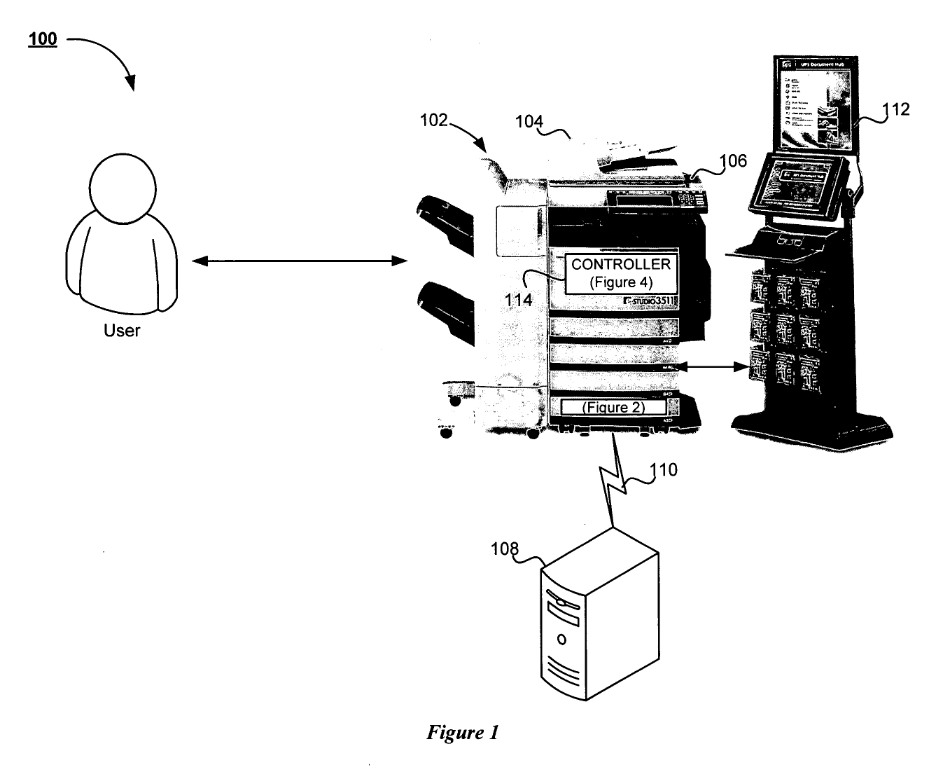

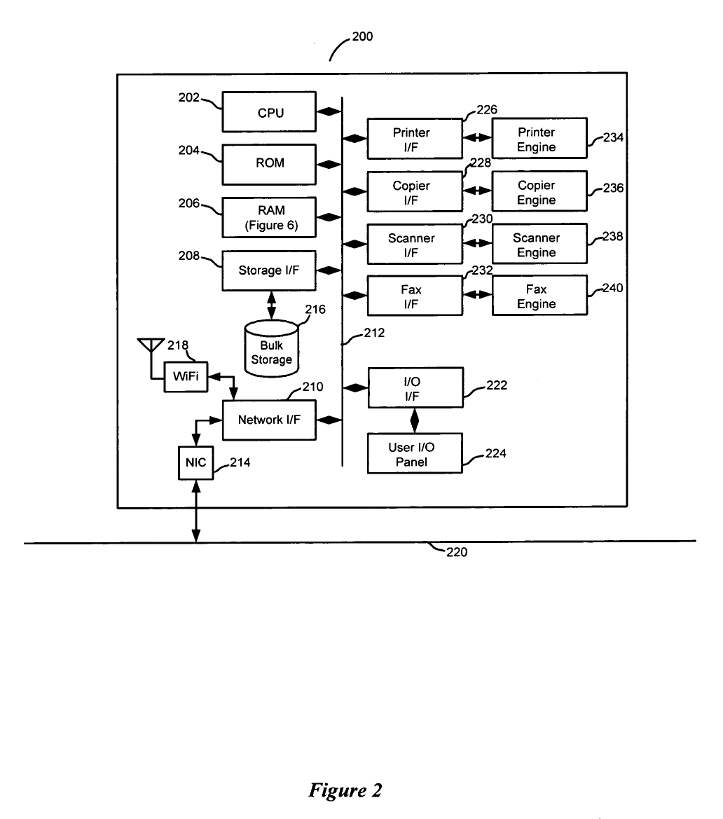

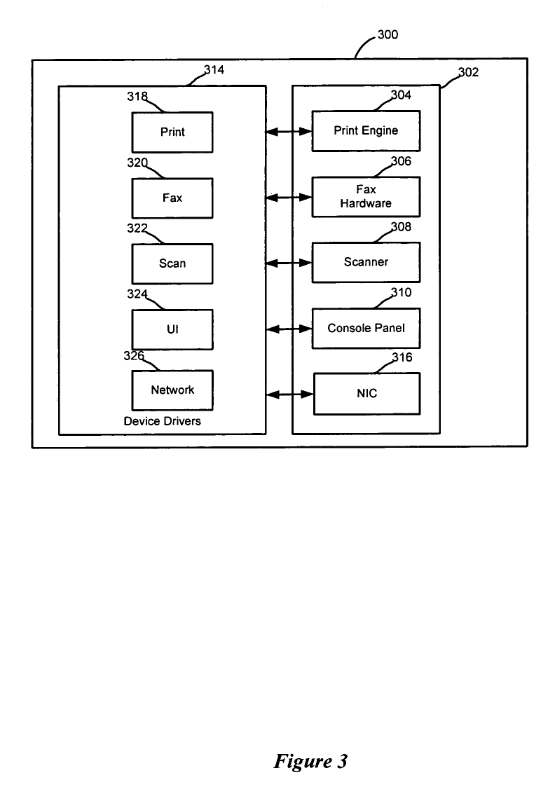

Referring now to FIG. 1, there is shown a diagram illustrating the system 100 in accordance with the subject application. As depicted in FIG. 1, the system 100 includes a document processing device 102, a network device 108, and a user-interface 112 associated with the document processing device 102. It will be appreciated by those skilled in the art that the document processing device 102 is advantageously represented in FIG. 1 as a multifunction peripheral device, suitably adapted to provide a variety of document processing services, such as, for example and without limitation, electronic mail, scanning, copying, facsimile, document management, printing, and the like. Suitable commercially available document processing devices include, but are not limited to, the Toshiba e-Studio Series Controller. The functioning of the document processing device 102 will better be understood in conjunction with the block diagram of FIG. 2 and the functional block diagram of FIG. 3, explained in greater detail below.

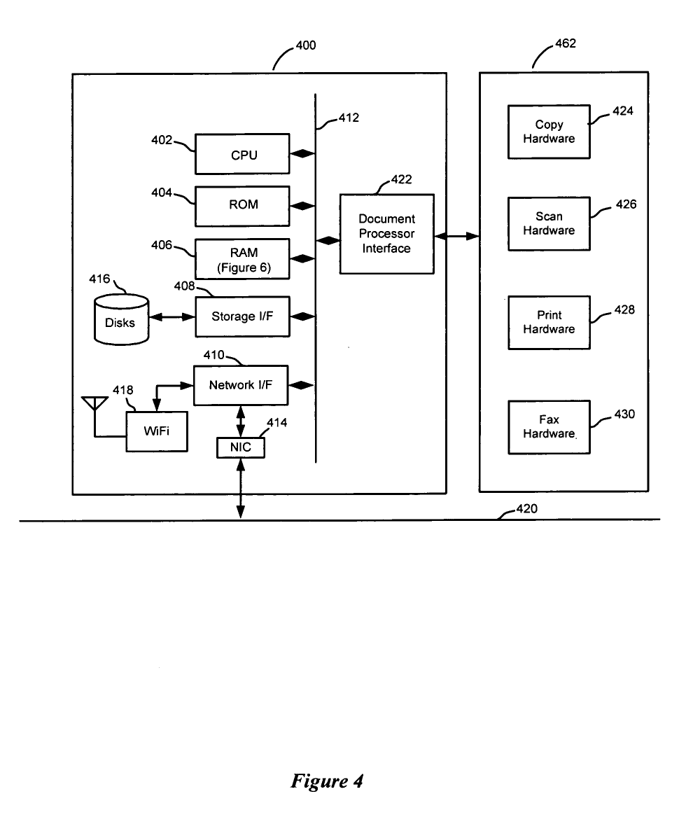

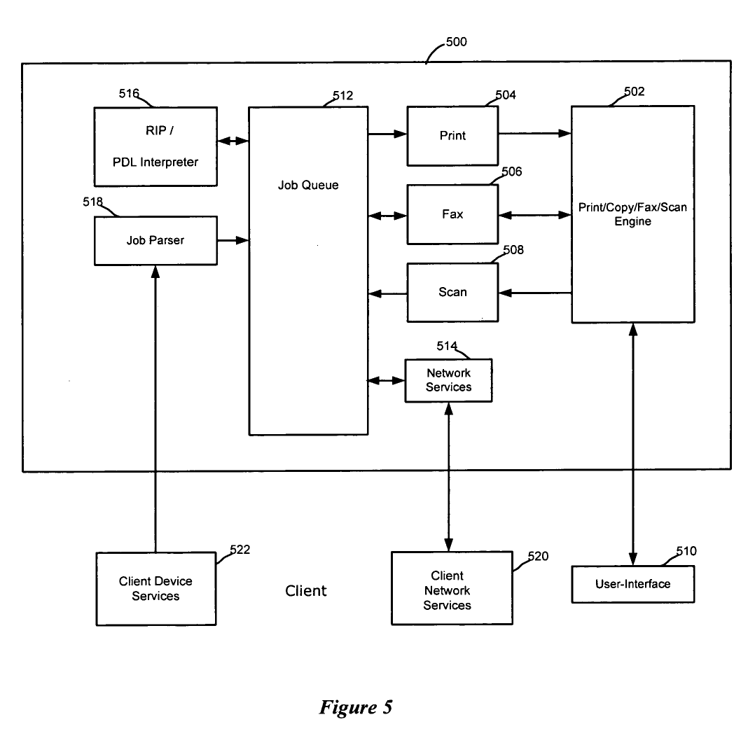

In one embodiment, the document processing device 102 is suitably equipped to receive a plurality of portable storage media, including, for example and without limitation, Firewire drive, USB drive, SD, MMC, XD, Compact Flash, Memory Stick, and the like. The document processing device 102 further includes an automatic document feeder 104 and a scanning unit 106. As will be appreciated by those skilled in the art, the automatic document feeder 104 is any automated means of transferring a page of a document to the scanning unit 106 known in the art. Preferably, the scanning unit 106 is any suitable means of rendering an electronic image known in the art. In accordance with the subject application, the document processing device 102 further incorporates a controller 114, suitably adapted to facilitate the operations of the first document processing device 102, as will be understood by those skilled in the art. Preferably, the controller 114 is embodied as hardware, software, or any suitable combination thereof, configured to control the operations of the associated document processing device 102, control the display of images via the user-interface, and the like. The functioning of the controller 114 will better be understood in conjunction with the block diagrams illustrated in FIGS. 4 and 5, explained in greater detail below.

In the preferred embodiment of the subject application, the document processing device 102 is communicatively coupled to an associated user-interface 112, such as a touch-screen interface, LCD display, or the like, which enables an associated user to interact directly with the document processing device 102. Preferably, the user-interface 112 allows the user to input document processing instructions and document processing requests to the document processing device 102. The skilled artisan will appreciate that suitable means of inputting such instructions or requests includes, for example and without limitation, an alpha-numeric keypad, touch-screen interface, keyboard, mouse, or any other user input devices known in the art. In accordance with the preferred embodiment of the subject application, the user-interface 112 displays a control program, whereby the associated user is able to select document processing operations, provide user identification information, purchase services, retrieve electronic mail, and the like. The document processing device 102 is in data communication with the network device via a suitable communication link 110. In accordance with the preferred embodiment of the subject application, the communications link 110 employed in accordance with the subject application includes, for example and without limitation, WiMax, 802.11a, 802.11b, 802.11g, 802.11(x), Bluetooth, the public switched telephone network, a proprietary communications network, infrared, optical, or any other suitable wired or wireless data transmission communications known in the art.

In one embodiment of the subject application, the communications link 110 is a computer network, to which the document processing device 102 and the network device 108 are communicatively coupled. It will be appreciated by those skilled in the art that such a computer network is any distributed communications network known in the art capable of allowing two or more electronic devices to exchange communications and data. In the instant embodiment, the computer network is capable of being implemented, for example and without limitation, on the Internet, a wide area network, a local area network, a personal area network, or any suitable combination thereof. The skilled artisan will further appreciate that such a computer network is comprised of physical layers and transport layers, incorporated within a plurality of conventional data transport mechanisms, including, for example and without limitation, Ethernet, Token-Ring, 802.11(x), or other wired or wireless data communications means.

It will be understood by those skilled in the art that the network device 108 is depicted in FIG. 1 as a server for illustration purposes only. As the skilled artisan will understand, the network device 108 shown in FIG. 1 is representative of any network capable computing or storage device, as are known in the art, including, for example and without limitation, a network mass storage device, a personal computer, a laptop computer, a personal data assistant, a proprietary networked portable electronic device, a web-enabled cellular telephone, a smart phone, or other web-enabled electronic device suitably capable of sending, receiving, or storing electronic data.

Turning now to FIG. 2, illustrated is a representative architecture of a suitable device 200 on which operations of the subject system 100 are completed. Included is a processor 202, suitably comprised of a central processor unit. However, it will be appreciated that processor 202 may advantageously be composed of multiple processors working in concert with one another as will be appreciated by one of ordinary skill in the art. Also included is a non-volatile or read only memory 204 which is advantageously used for static or fixed data or instructions, such as BIOS functions, system functions, system configuration data, and other routines or data used for operation of the server 200.

Also included in the server 200 is random access memory 206, suitably formed of dynamic random access memory, static random access memory, or any other suitable, addressable memory system. Random access memory provides a storage area for data instructions associated with applications and data handling accomplished by processor 202.

A storage interface 208 suitably provides a mechanism for volatile, bulk or long term storage of data associated with the device 200. The storage interface 208 suitably uses bulk storage, such as any suitable addressable or serial storage, such as a disk, optical, tape drive and the like as shown as 216, as well as any suitable storage medium as will be appreciated by one of ordinary skill in the art.

A network interface subsystem 210 suitably routes input and output from an associated network allowing the device 200 to communicate to other devices. Network interface subsystem 210 suitably interfaces with one or more connections with external devices to the device 200. By way of example, illustrated is at least one network interface card 214 for data communication with fixed or wired networks, such as Ethernet, token ring, and the like, and a wireless interface 218, suitably adapted for wireless communication via means such as WiFi, WiMax, wireless modem, cellular network, or any suitable wireless communication system. It is to be appreciated however, that the network interface subsystem suitably utilizes any physical or non-physical data transfer layer or protocol layer as will be appreciated by one of ordinary skill in the art. In the illustration, the network interface card 214 is interconnected for data interchange via a physical network 220, suitably comprised of a local area network, wide area network, or a combination thereof.

Data communication between the processor 202, read only memory 204, random access memory 206, storage interface 208 and network subsystem 210 is suitably accomplished via a bus data transfer mechanism, such as illustrated by bus 212.

Suitable executable instructions on the device 200 facilitate communication with a plurality of external devices, such as workstations, document processing devices, other servers, or the like. While, in operation, a typical device operates autonomously, it is to be appreciated that direct control by a local user is sometimes desirable, and is suitably accomplished via an optional input/output interface 222 to a user input/output panel 224 as will be appreciated by one of ordinary skill in the art.

Also in data communication with bus 212 are interfaces to one or more document processing engines. In the illustrated embodiment, printer interface 226, copier interface 228, scanner interface 230, and facsimile interface 232 facilitate communication with printer engine 234, copier engine 236, scanner engine 238, and facsimile engine 240, respectively. It is to be appreciated that a device 200 suitably accomplishes one or more document processing functions. Systems accomplishing more than one document processing operation are commonly referred to as multifunction peripherals or multifunction devices.

Turning now to FIG. 3, illustrated is a suitable document processing device, e.g., the document processing device 102 of FIG. 1, for use in connection with the disclosed system 100. FIG. 3 illustrates suitable functionality of the hardware of FIG. 2 in connection with software and operating system functionality as will be appreciated by one of ordinary skill in the art. The document processing device 300 suitably includes an engine 302 which facilitates one or more document processing operations.

Document processing engine 302 suitably includes a print engine 204, facsimile engine 206, scanner engine 308 and console panel 310. Printer engine 304 allows for output of physical documents representative of an electronic document communicated to the processing device 300. Facsimile engine 306 suitably communicates to or from external facsimile devices via a device, such as fax modem 312.

A scanner 308 suitably functions to receive hard copy documents and in turn image data corresponding thereto. A suitable user interface, such as that interface 310, suitably includes a console to allow for input receipt of instructions and display of information to an associated user. It will be appreciated that the scanner 308 is suitably used in connection with input of tangible documents into electronic form in bitmapped, vector, or page description language format, and is also suitably configured for optical character recognition. Tangible document scanning also suitably functions to facilitate facsimile output thereof.

In the illustration of FIG. 3, the document processing engine also comprises an interface 316 with a network, suitably comprised of a network interface card. It will be appreciated that a network thoroughly accomplishes that interchange via any suitable physical and non-physical layer, such as wired, wireless, or optical data communication.

The document processing engine 302 is suitably in data communication with one or more device drivers 314, which device drivers allow for data interchange from the document processing engine 302 to one or more physical devices to accomplish the actual document processing operations. Such document processing operations include one or more of printing via driver 318, facsimile communication via driver 320, scanning via driver 322 and a user interface functions via driver 324. It will be appreciated that these various devices are integrated with one or more corresponding engines associated with document processing engine 302. It is to be appreciated that any set or subset of document processing operations are contemplated herein. Document processors which include a plurality of available document processing options are referred to as multi-function peripherals.

Turning now to FIG. 4, illustrated is a representative architecture of a suitable controller 400 on which operations of the subject system are completed. Included is a processor 402, suitably comprised of a central processor unit. However, it will be appreciated that processor 402 may advantageously be composed of multiple processors working in concert with one another as will be appreciated by one of ordinary skill in the art. Also included is a non-volatile or read only memory 404 which is advantageously used for static or fixed data or instructions, such as BIOS functions, system functions, system configuration data, and other routines or data used for operation of the controller 400.

Also included in the controller 400 is random access memory 406, suitably formed of dynamic random access memory, static random access memory, or any other suitable, addressable and writable memory system. Random access memory provides a storage area for data instructions associated with applications and data handling accomplished by processor 402.

A storage interface 408 suitably provides a mechanism for non-volatile, bulk or long term storage of data associated with the controller 400. The storage interface 408 suitably uses bulk storage, such as any suitable addressable or serial storage, such as a disk, optical, tape drive and the like as shown as 416, as well as any suitable storage medium as will be appreciated by one of ordinary skill in the art.

A network interface subsystem 410 suitably routes input and output from an associated network allowing the controller 400 to communicate to other devices. Network interface subsystem 410 suitably interfaces with one or more connections with external devices to the device 400. By way of example, illustrated is at least one network interface card 414 for data communication with fixed or wired networks, such as Ethernet, token ring, and the like, and a wireless interface 418, suitably adapted for wireless communication via means such as WiFi, WiMax, wireless modem, cellular network, or any suitable wireless communication system. It is to be appreciated however, that the network interface subsystem suitably utilizes any physical or non-physical data transfer layer or protocol layer as will be appreciated by one of ordinary skill in the art. In the illustration, the network interface 414 is interconnected for data interchange via a physical network 420, suitably comprised of a local area network, wide area network, or a combination thereof.

Data communication between the processor 402, read only memory 404, random access memory 406, storage interface 408 and network interface subsystem 410 is suitably accomplished via a bus data transfer mechanism, such as illustrated by bus 412.

Also in data communication with the bus 412 is a document processor interface 422. The document processor interface 422 suitably provides connection with hardware 462 to perform one or more document processing operations. Such operations include copying accomplished via copy hardware 424, scanning accomplished via scan hardware 426, printing accomplished via print hardware 428, and facsimile communication accomplished via facsimile hardware 430. It is to be appreciated that a controller suitably operates any or all of the aforementioned document processing operations. Systems accomplishing more than one document processing operation are commonly referred to as multifunction peripherals or multifunction devices.

Functionality of the subject system is accomplished on a suitable document processing device that includes the controller 400 of FIG. 4 as an intelligent subsystem associated with a document processing device, e.g., the document processing device 102 of FIG. 1. In the illustration of FIG. 5, controller function 500 in the preferred embodiment, includes a document processing engine 502. A suitable controller functionality is that incorporated into the Toshiba e-Studio system in the preferred embodiment. FIG. 5 illustrates suitable functionality of the hardware of FIG. 4 in connection with software and operating system functionality as will be appreciated by one of ordinary skill in the art.

In the preferred embodiment, the engine 502 allows for printing operations, copy operations, facsimile operations and scanning operations. This functionality is frequently associated with multi-function peripherals, which have become a document processing peripheral of choice in the industry. It will be appreciated, however, that the subject controller does not have to have all such capabilities. Controllers are also advantageously employed in dedicated or more limited purposes document processing devices that are subset of the document processing operations listed above.

The engine 502 is suitably interfaced to a user interface panel 510, which panel allows for a user or administrator to access functionality controlled by the engine 502. Access is suitably via an interface local to the controller, or remotely via a remote thin or thick client.

The engine 502 is in data communication with printer function 504, facsimile function 506, and scan function 508. These devices facilitate the actual operation of printing, facsimile transmission and reception, and document scanning for use in securing document images for copying or generating electronic versions.

A job queue 512 is suitably in data communication with printer function 504, facsimile function 506, and scan function 508. It will be appreciated that various image forms, such as bit map, page description language or vector format, and the like, are suitably relayed from scan function 508 for subsequent handling via job queue 512.

The job queue 512 is also in data communication with network services 514. In a preferred embodiment, job control, status data, or electronic document data is exchanged between job queue 512 and network services 514. Thus, suitable interface is provided for network based access to the controller 500 via client side network services 520, which is any suitable thin or thick client. In the preferred embodiment, the web services access is suitably accomplished via a hypertext transfer protocol, file transfer protocol, uniform data diagram protocol, or any other suitable exchange mechanism. Network services 514 also advantageously supplies data interchange with client side services 520 for communication via FTP, electronic mail, TELNET, or the like. Thus, the controller function 500 facilitates output or receipt of electronic document and user information via various network access mechanisms.

Job queue 512 is also advantageously placed in data communication with an image processor 516. Image processor 516 is suitably a raster image process, page description language interpreter or any suitable mechanism for interchange of an electronic document to a format better suited for interchange with device services such as printing 504, facsimile 506 or scanning 508.

Finally, job queue 512 is in data communication with a parser 518, which parser suitably functions to receive print job language files from an external device, such as client device services 522. Client device services 522 suitably include printing, facsimile transmission, or other suitable input of an electronic document for which handling by the controller function 500 is advantageous. Parser 518 functions to interpret a received electronic document file and relay it to a job queue 512 for handling in connection with the afore-described functionality and components.

In operation, the user logs onto the document processing device 102, via the associated user-interface 112. As will be appreciated by those skilled in the art, user provided logon information enables the document processing device 102 to retrieve account information, authorization information, address information, and the like, corresponding to the document processing services available via the document processing device 102. In accordance with one embodiment of the subject application, the user logs onto the document processing device 102 by inputting a user identification and password combination. The user then selects a document processing operation, such as copy, fax, scan to storage, scan to electronic mail, or the like. The document processing device 102 then determines whether a source document is present in the automatic document feeder 104 or on the scanner 106. In accordance with one aspect of the subject application, the document processing device 102 performs a scan and detects whether the automatic document feeder 104 or the scanner 106 contain a source document based on the results of the scan. When the document processing device 102 detects the presence of a source document on either the automatic document feeder 104 or on the scanner 106, the selected document processing operation is performed. In one particular embodiment, the document processing device 102 determines whether a source document is available on a portable storage medium or network storage. To accomplish this, the document processing device 102 accesses the portable storage medium or network storage to determine whether the designated location contains the source document. Preferably, prior to performing the selected document processing operation, a fee associated with the operation is calculated and presented to the user via the associated user-interface 112. The user then selects a payment method, such as, for example and without limitation, credit card, cash, accounts debiting, or the like. Upon receipt of the payment, the selected document processing operation is performed by the document processing device 102.

When the document processing device 102 determines that a source document is absent, a visible alert is generated representing the lack of a source document in the automatic document feeder 104 or the scanner 106. In accordance with one embodiment of the subject application, the visible alert is a thumbnail representation of a blank document displayed to the user via the associated user-interface 112. In alternate embodiments, the visible alert includes, for example and without limitation, a pop-up window on the user-interface 112, a flashing warning, or the like. The absence of a source document directs the document processing device 102 to prompt the user to provide a source document. Preferably, this prompting includes the display of a graphical representation of the document processing device 102 illustrated on the associated user-interface 112, along with a ready icon, which is selected by the user after placement of the source document in the automatic document feeder 104 or on the scanner 106, or after insertion of the portable storage medium or network location. A suitable template screen displayed on the associated user-interface 112 is illustrated in FIG. 3, discussed in greater detail below.

Once the user has indicated that a source document has been provided, e.g., by selecting the ready icon, the document processing device 102 then determines whether a source document has in fact been placed on the automatic document feeder 104 or on the scanner 106. When no source document is detected by the document processing device 102, the visible alert is again generated requesting the user to place the source document on the feeder 104 or on the scanner 106. When a source document is detected by the document processing device 102, either on the automatic document feeder 104 or on the scanner 106, the user is then prompted, via the associated user-interface 112, to select a desired payment method. As will be appreciated by those skilled in the art, suitable payment methods include, for example and without limitation, a payment coupon, cash, credit card, account debit, account billing, or the like. The charges associated with the selected operation are then calculated and displayed to the user on the associated user-interface 112. The user then selects a method of payment, e.g., inserts a credit card, inputs a pre-paid coupon, inputs a customer account, or the like. Following verification of the receipt of the payment, the document processing device 102 performs the selected document processing operation.

For example, when the selected document processing operation is scan to electronic mail, the document processing device 102 performs a scan of the source document, thereby generating electronic image data representative of the source document. The fees associated with this operation are then displayed to the user, prompting the user to select a payment method. The user inputs a pre-paid coupon, whereupon the amount associated with the selected document processing operation is debited from the amount of the coupon. The document processing device then generates an electronic mail message, inclusive of the image data. This electronic mail message is then transmitted, via the communications link 110, to the network device 108, e.g., a personal computer associated with the intended recipient of the electronic mail message. When the selected operation is, for example a copy operation, a copy of the source document is printed once payment for the copy operation has been received.

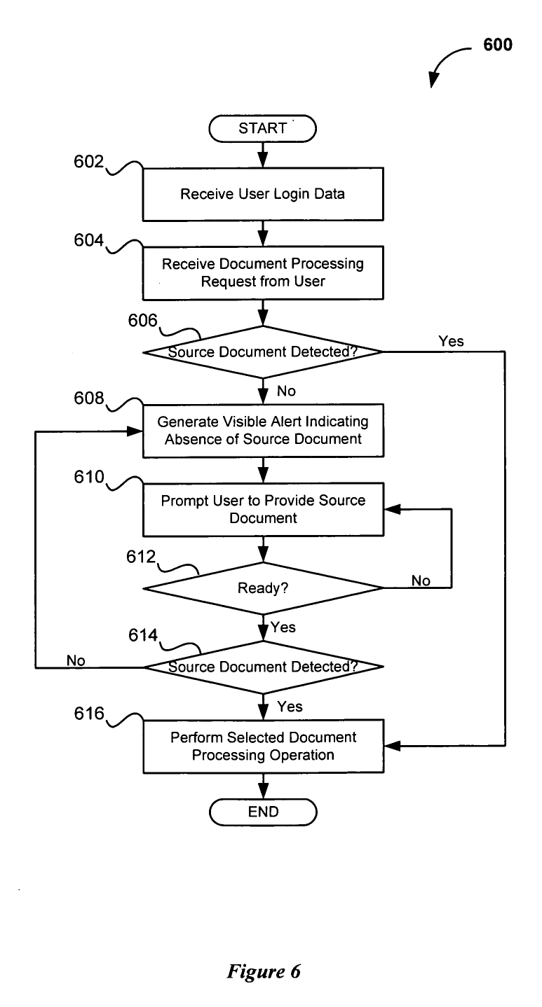

The skilled artisan will appreciate that additional embodiments are contemplated in accordance with the system 100 described above in FIGS. 1, 2, 3, 4, and 5, and in conjunction with the methodology illustrated in FIG. 6. The skilled artisan will better understand the system 100 illustrated in FIG. 1 and the components illustrated in FIGS. 2, 3, 4, and 5, when viewed in conjunction with the methodology described in FIG. 6. Turning now to FIG. 6, there is shown a flowchart 600 illustrating the methodology for the conditional commencement of a document processing device according to the subject application. At step 602, the document processing device 102 receives user login data corresponding to a user identification and associated password. As will be appreciated by those skilled in the art, the receipt of login data enables the document processing device 102 to determine the identity of the user, the user's pre-paid account information, if any, and other information corresponding to the user. Preferably, the login data is associated with user data stored on an external, backend server (not shown), to which all document processing devices in the document processing services systems are connected. The skilled artisan will understand that such user information is capable of including, but is not limited to, authorization rights for particular operations, address book data, previously stored electronic documents, and the like.

At step 604, the document processing device 602 receives a document processing request from the user. As will be understood by those skilled in the art, the document processing request is generated via user interaction with the user-interface 112, wherein the user selects a desired document processing operation from among those services offered by the corresponding document processing device 102. A determination is then made by the controller 114 at step 606 whether a source document is detected by the document processing device 102. It will be appreciated by those skilled in the art that the detection of a source document includes the detection of the presence of a hardcopy document on the automatic document feeder 104 or on the scanner 106, as well as the presence of an electronic document, such as a document stored on a portable storage medium or at a user designated location. Thus, when the selected document processing operation is to be performed on a source document already in electronic form and accessible by the document processing device 102, the source document is deemed to be present. It will be understood by those skilled in the art that the document processing device 102 searches the designated portable storage medium or electronic mail message attachment for the selected electronic document. Similarly, when the selected document processing operation is to be performed on a hardcopy source document, the document processing device 102 performs a scan to detect the presence or absence of a source document on the automatic document feeder 104 or the scanner 106.

When a source document is detected by the controller 114 associated with the document processing device 102 at step 606, flow proceeds to step 616, whereupon the selected document processing operation is performed. The skilled artisan will appreciate that, as discussed in greater detail above, one aspect of the subject application provides for the calculation and payment of any fees associated with the selected document processing operation prior to the performance thereof. When no source document is detected by the controller 114 associated with document processing device 102 at step 606, flow proceeds to step 608, wherein a visible alert indicating the absence of a source document is generated and displayed to the user. Preferably, the visible alert informs the user that the automatic document feeder 104, the scanner 106 does not contain a source document using the associated user-interface 112. In accordance with embodiment of the subject application, when the user identifies an electronic document on a portable storage medium, as an attachment to an electronic mail message, or stored on a network storage, but the selected electronic document is not found by the document processing device 102 at the designated location, the document is deemed not detected at step 606 and a visible alert is generated at step 608. As will be appreciated by those skilled in the art, suitable notification of the user includes, but is not limited to, a graphical representation depicting the absence of the source document at the document processing device 102, or alternatively at the designated storage location.

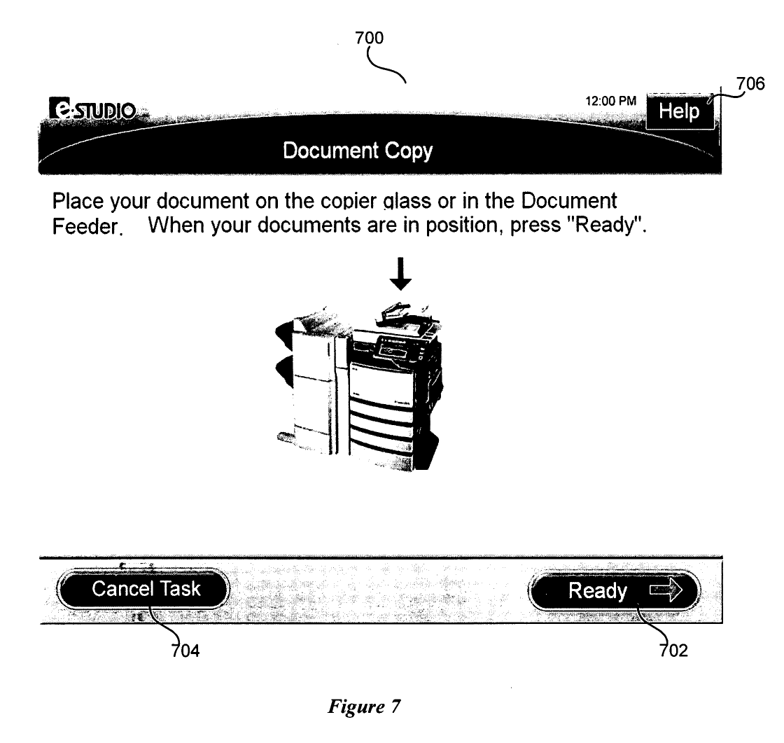

The user is then prompted, via the associated user-interface 112, to provide the source document on which the requested document processing service is to be performed at step 210. The skilled artisan will understand that the prompting of the user to provide the source document is capable of including, for example and without limitation, the placement of an original on the automatic document feeder 104, on the scanner 106, the insertion of a portable storage medium, an updated electronic mail message, or a revised network location of the source document. A graphical representation of a user prompt by the associated user-interface 112 is illustrated in the template screen 700 shown in FIG. 7. As shown in FIG. 7, the screen template 700 includes a ready icon 702, a cancel icon 704, and a help icon 706. The function of cancel icon 704 and the help icon 706 will be readily apparent to one of ordinary skill in the art. Thus, selection of the cancel icon 704 terminates the current operation, whereas selection of the help icon 706 displays various help topics, as are known in the art, with respect to document processing devices. The skilled artisan will further appreciate that selection of the ready icon 702 indicates to the document processing device 102 that the user has provided a source document, which corresponds to the determination step 612, as discussed below.

After prompting the user at step 610 to provide a source document with the display of the screen template 700, flow progresses to step 612, whereupon a determination is made whether the user has selected the ready icon 702. When the user has not selected the ready icon 702, operations remain with the display of the source document prompt at step 610, e.g., displaying the prompting screen 700. When the user has selected the ready icon 702 at step 612, flow proceeds to step 614, wherein the controller 114 associated with the document processing device 102 determines if a source document has in fact been provided by the user. As mentioned above, the determination by the controller 114 as to the presence or absence of a source document is accomplished by directing the document processing device 102 to begin performing a scan and detecting whether the automatic document feeder 104 or the scanner 106 contain a source document. When no source document has been detected, operations return to step 608, whereupon the visible alert indicating the absence of a source document is displayed to the user. When the source document is present, on the automatic document feeder 104, on the scanner 106, or designated storage location, flow proceeds to step 616. At step 616, the document processing device 102 performs the selected operation.

It will be appreciated by those skilled in the art that in accordance with one particular embodiment of the subject application, prior to performing the selected document processing operation, the document processing device 102 calculates any fees associated with the performance of the operation. The calculated fees are then accepted by the user and selection of a payment method is made by the user. The payment method is then submitted to a backend system (not shown), which performs verification on the payment, returning such verification to the document processing device 102. Once the payment has been verified, the document processing operation is performed by the document processing device 102.

The invention extends to computer programs in the form of source code, object code, code intermediate sources and partially compiled object code, or in any other form suitable for use in the implementation of the invention. Computer programs are suitably standalone applications, software components, scripts or plug-ins to other applications. Computer programs embedding the invention are advantageously embodied on a carrier, being any entity or device capable of carrying the computer program: for example, a storage medium such as ROM or RAM, optical recording media such as CD-ROM or magnetic recording media such as floppy discs. The carrier is any transmissible carrier such as an electrical or optical signal conveyed by electrical or optical cable, or by radio or other means. Computer programs are suitably downloaded across the Internet from a server. Computer programs are also capable of being embedded in an integrated circuit. Any and all such embodiments containing code that will cause a computer to perform substantially the invention principles as described, will fall within the scope of the invention.

The foregoing description of a preferred embodiment of the invention has been presented for purposes of illustration and description. It is not intended to be exhaustive or to limit the invention to the precise form disclosed. Obvious modifications or variations are possible in light of the above teachings. The embodiment was chosen and described to provide the best illustration of the principles of the invention and its practical application to thereby enable one of ordinary skill in the art to use the invention in various embodiments and with various modifications as are suited to the particular use contemplated. All such modifications and variations are within the scope of the invention as determined by the appended claims when interpreted in accordance with the breadth to which they are fairly, legally and equitably entitled.

What is claimed:

1. A conditional document processor commencement system comprising:
input means adapted for receiving status data from an associated document processing device, which status data is representative of at least one of a presence or absence of a tangible document in a functionally proximate relationship relative to the associated document processing device for processing thereby;
means adapted for receiving an operation commencement input from an associated user, which input is directed to commence at least one selected document processing operation on an associated, tangible document by the associated document processing device;
means adapted for selectively generating a visual alert to the associated user after receipt of operation commencement input and in accordance with received status data, which visual alert includes a display of information informing the associated user that the tangible document is not functionally proximate to the at least one selected document processing device; and
means adapted for selectively commencing a document processing operation on the tangible document when received status data indicates a functionally proximate relationship.

2. The conditional document processor commencement system of claim 1 wherein the document processing device includes at least one of a copying device, facsimile device, a scanning device, a printing device, and a multifunctional peripheral device.

3. The conditional document processor commencement system of claim 1 wherein the document processing device includes a scanning device, and wherein the system further comprises:
means adapted for commencing a scanning operation of the scanning device;
testing means adapted for testing scan data resultant from the scanning operation; and
means adapted for selectively generating the status data in accordance with an output of the testing means.

4. The conditional document processor commencement system of claim 3 further comprising means adapted for generating a thumbnail display corresponding to the scan data.

5. The conditional document processor commencement system of claim 3 wherein the scanning device generates an electronic document representative of an image associated with the tangible document.

6. The conditional document processor commencement system of claim 5 wherein the scanning device further comprises means adapted for transmitting the electronic document to at least one selected recipient device.

7. The conditional document processor commencement system of claim 3 wherein the scanning device generates a tangible copy of an image associated with the tangible document.

8. A conditional document processor commencement method comprising the steps of:
receiving status data from an associated document processing device, which status data is representative of at least one of a presence or absence of a tangible document in a functionally proximate relationship relative to the associated document processing device for processing thereby;
receiving an operation commencement input from an associated user, which input is directed to commence at least one selected document processing operation on an associated, tangible document by the associated document processing device;
selectively generating a visual alert to the associated user after receipt of operation commencement input and in accordance with received status data, which visual alert includes a display of information informing the associated user that the tangible document is not functionally proximate to the at least one selected document processing device; and
selectively commencing a document processing operation on the tangible document when received status data indicates a functionally proximate relationship.

9. The conditional document processor commencement method of claim 8 wherein the document processing device includes at least one of a copying device, facsimile device, a scanning device, a printing device, and a multifunctional peripheral device.

10. The conditional document processor commencement method of claim 8 further comprising the steps of:
commencing a scanning operation via scanning device associated with the document processing device;
testing scan data resultant from the scanning operation; and
selectively generating the status data in accordance with an output of the testing means.

11. The conditional document processor commencement method of claim 10 further comprising the step of generating a thumbnail display corresponding to the scan data.

12. The conditional document processor commencement method of claim 10 further comprising the step of generating an electronic document representative of an image associated with the tangible document.

13. The conditional document processor commencement method of claim 12 further comprising the step of transmitting the electronic document to at least one selected recipient device.

14. The conditional document processor commencement method of claim 10 further comprising the step of generating a tangible copy of an image associated with the tangible document.

15. A computer-implemented method for conditional document processor commencement comprising the steps of:
receiving status data from an associated document processing device, which status data is representative of at least one of a presence or absence of a tangible document in a functionally proximate relationship relative to the associated document processing device for processing thereby;
receiving an operation commencement input from an associated user, which input is directed to commence at least one selected document processing operation on an associated, tangible document by the associated document processing device;
selectively generating a visual alert to the associated user after receipt of operation commencement input and in accordance with received status data, which visual alert includes a display of information informing the associated user that the tangible document is not functionally proximate to the at least one selected document processing device; and
selectively commencing a document processing operation on the tangible document when received status data indicates a functionally proximate relationship.

16. The computer-implemented method for conditional document processor commencement of claim 15 wherein the document processing device includes at least one of a copying device, facsimile device, a scanning device, a printing device, and a multifunctional peripheral device.

17. The computer-implemented method for conditional document processor commencement of claim 15 further comprising the steps of:
commencing a scanning operation via a scanning device associated with the document processing device;
testing scan data resultant from the scanning operation; and
selectively generating the status data in accordance with an output of the testing means.

18. The computer-implemented method for conditional document processor commencement of claim 17 further comprising the step of generating a thumbnail display corresponding to the scan data.

19. The computer-implemented method for conditional document processor commencement of claim 17 further comprising the step of generating an electronic document representative of an image associated with the tangible document.

20. The computer-implemented method for conditional document processor commencement of claim 19 further comprising the step of transmitting the electronic document to at least one selected recipient device.
